(19) United States
(12) Patent Application Publication
(10) Pub. No.: US 2021/0030628 A1
(43) Pub. Date: Feb. 4, 2021

(54) Medical Device Position Notification System

(71) Applicant: Avent, Inc., Alpharetta, GA (US)

(72) Inventor: James M. Takeuchi, Woodstock, GA (US)

(21) Appl. No.: 16/526,119

(22) Filed: Jul. 30, 2019

(51) Int. Cl. A61J 15/00

(52) U.S. Cl. CPC A61J 15/0084; A61J 15/0003; A61J 2205/50; A61J 2205/40; A61J 2200/70

(57) ABSTRACT

A medical device position notification system including a negative pressure device. The medical device is configured to be inserted into an orifice of the patient. The negative pressure device provides information related to the position of the medical device in the patient's body and communicates the information in real-time. The negative pressure device may also be coupled to a sensor, processor, and display device and indicates the position of the medical device in the patient's body in real-time.

### FIELD OF THE INVENTION

The subject matter of the present invention relates generally to a system and method for notification of the position of a medical device within the body.

### BACKGROUND

Physicians and other health care providers frequently use catheters to treat patients. The known catheters include a tube which is inserted into the human body. Certain catheters are inserted through the patient's nose or mouth for treating the gastrointestinal tract. These catheters, sometimes known as enteral catheters, typically include feeding tubes. The feeding tube lies in the stomach or intestines, and a feeding bag delivers liquid nutrient, liquid medicine or a combination of the two to the patient.

When using these known enteral catheters, it is important to place the end of the catheter at the proper location within the human body. Erroneous placement of the catheter tip may injure or harm the patient. For example, if the health care provider erroneously places an enteral catheter into the patient's trachea, lungs, or other regions of the respiratory system rather than through the esophagus and to the stomach to reach the desired location in the digestive tract for delivering nutrients or medicine, liquid may be introduced into the lungs with harmful, and even fatal, consequences. In particular, the esophagus of the digestive tract and the trachea of the respiratory system are in close proximity to each other and are blind to the health care provider during catheter placement, which creates a dangerous risk for erroneous catheter placement.

In some cases, health care providers use X-ray machines to gather information about the location of catheters within the body. There are several disadvantages with using X-ray machines. For example, these machines are relatively large and heavy, consume a relatively large amount of energy and expose the patient to a relatively high degree of X-ray radiation. Also, these machines are typically not readily accessible for use because, due to their size, they are usually installed in a special X-ray room. This room can be far away from the patient's room. Therefore, health care providers can find it inconvenient to use these machines for performing catheter insertion procedures. Moreover, even X-rays are not necessarily conclusive as to the location of the catheter tip, as the natural and continuous movement of the internal organs can make it difficult for the physician interpreting the X-ray to be sure of the actual location of the distal end of the catheter. In addition, using X-ray technology is expensive and is a time-consuming task that can create unnecessary delays in delivering critical nutrients to the patient.

Another existing catheter locating means involves using an electromagnetic coil positioned inside the catheter and an electromagnetic coil locating receiver outside of the patient's body. The electromagnetic coil is generally incorporated into a stylet or guide wire which is inserted within the catheter. The coil locating receiver can be used to determine the distance the coil is from the receiver and its depth in the patient's body and can communicate with a display to show a reference image of a non-subject body and an image of the coil located on the display with the reference image. However, these systems also have several disadvantages. For example, the coil locating receiver is a large device that must rest in a precise location outside the patient's body and does not permit for adjustments due to each individual patient's anatomical size or shape. However, a patient undergoing a feeding tube placement will be agitated and sudden movements are expected, which can move the coil locating receiver, thus increasing the likelihood of positional errors or complications in locating the catheter. Additionally, these existing systems can only display the coil location over a reference image of a non-subject (i.e., a generic patient) body without reference to the individual patient's particular anatomy. Thus, these existing systems can only generate generic warnings or alerts when a deviation from an intended path within the body is estimated. Such generic warnings or alerts are easily ignored by a health care provider because they provide little specific, actual information regarding the position of the catheter and do not adequately capture a health care provider's attention. Therefore, health care providers can estimate the positioning of the catheter using the electromagnetic coil and coil locating receiver but cannot estimate or view the specific patient's anatomy.

Consequently, there is a need for a system for notifying a user of the positioning of a medical device within a patient's body in real-time to ensure more accurate catheter placement. In particular, a notification system that is easy to use and provides a clear deviation alert when the medical device is improperly positioned would also be useful.

### SUMMARY

The disclosure is directed to a medical device position notification system and methods of use thereof. The medical device position notification system includes a negative pressure device that articulates information regarding the position of the medical device in a patient's body.

In some embodiments, provided is a medical device position notification system that may include a medical device, wherein at least a portion of the medical device is configured to be inserted into a patient's body, and a negative pressure device, wherein the negative pressure device is configured to provide information relating to the position of the medical device in the patient's body.

Also provided are methods for medical device position guidance. The methods may include the following: providing a medical device, wherein at least a portion of the medical device is configured to be inserted into the body; providing a negative pressure device, wherein the negative pressure device is configured to be coupled to the medical device; inserting the medical device into an orifice of the body; activating the negative pressure device to generate negative pressure or a vacuum; and observing the negative pressure device or a display device configured to the negative pressure device to determine the position of the medical device within the patient's body.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes references to the appended figures, in which:

FIG. 1A illustrates a perspective view of a medical device position notification system according to various embodiments of the present invention;

FIG. 1B illustrates a perspective view of a medical device position notification system where the medical device is located in the esophagus of a patient;

FIG. 1C illustrates a perspective view of a medical device position notification system where the medical device is located in the trachea of a patient;

FIG. 2A illustrates a perspective view of a medical device position notification system according to various embodiments of the present invention;

FIG. 2B illustrates a perspective view of a medical device notification system where the medical device is located in the esophagus or gastrointestinal tract of a patient;

FIG. 2C illustrates a perspective view of the medical device position notification system where the medical device is located in the trachea or airway of a patient;

FIG. 3 illustrates a perspective view of a medical device position notification system in the form of an enteral catheter according to various embodiments of the present invention;

FIG. 4 illustrates a perspective view of a medical device position notification system in the form of an enteral catheter according to various embodiments of the present invention;

FIG. 5 illustrates a perspective view of a medical device position notification system in the form of an enteral catheter according to various embodiments of the present invention;

FIG. 6 illustrates a perspective view of a medical device position notification system in the form of an enteral catheter according to various embodiments of the present invention;

FIG. 7 illustrates a perspective view of a medical device position notification system in the form of an enteral catheter according to various embodiments of the present invention;

FIG. 8 illustrates a perspective view of a medical device position notification system according to various embodiments of the present invention;

FIG. 9 illustrates a perspective view of a medical device position notification system in the form of an enteral catheter according to various embodiments of the present invention;

FIG. 10A illustrates a perspective view of a graph generated by a medical device position notification system according to various embodiments of the present invention; and

FIG. 10B illustrates a perspective view of a graph generated by a medical device position notification system according to various embodiments of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “about,” “approximately,” or “generally,” when used to modify a value, indicates that the value can be raised or lowered by 5% and remain within the disclosed embodiment.

As used herein, the term “in-scale” indicates an article or image that is in proportion to its surroundings, with all parts accurately sized and proportioned in relation to each other.

The medical device position notification system of the present disclosure is based on vacuum/suction methodology and may be utilized to detect medical device placement, i.e. nasogastric or nasojejunal tube placement, in the airway without the need for cumbersome equipment, electronics, or complicated techniques. Indeed, the effectiveness of the disclosure of the medical device position notification system herein is predicated on anatomical differences between the esophagus and the trachea. For example, the esophagus contains no significant structure support and readily collapses when negative pressure is applied. Conversely, the trachea is lined with semi-rigid cartilage that maintains patency in the airway, even under moderate negative pressure. Thus, applying a negative pressure through a tube or catheter, including through the inner lumen of the nasogastric/nasojejunal tube, during placement can differentiate the location of the catheter or tube's tip based on this anatomical difference.

Generally speaking, the present disclosure is directed to a medical device position notification system that includes a negative pressure device. The negative pressure device may be attached to a medical device, e.g. a catheter, that is configured to be inserted into a patient's body. The negative pressure device is configured to visually alert in real time when at least a portion of the medical device is in the patient's trachea or airway versus the esophagus or gastrointestinal tract. The present inventors have found that the medical device position notification system and method(s) described in more detail herein are easy to use and provide a real time information and signaling concerning the placement of a medical device, such as a catheter or enteral catheter, within a patient's body.

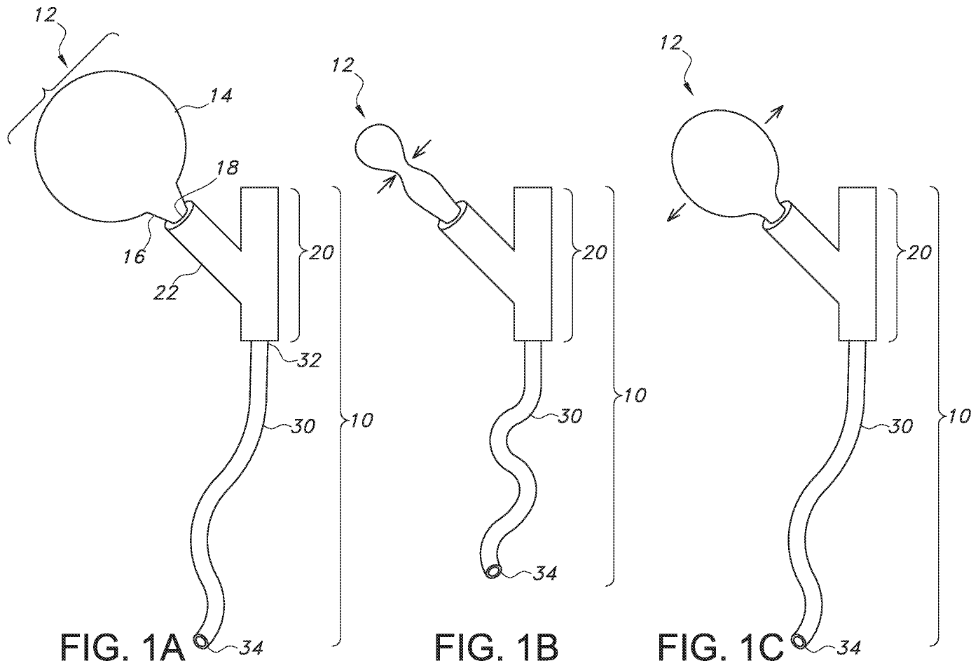

Particularly, the system of the present invention implements a negative pressure device that is easily connected to a medical device, such as a catheter, and can be utilized by a healthcare provider to signal whether the medical device is in the patient's gastrointestinal tract or respiratory tract, thus confirming the position of the catheter in the patient's body. The specific features of the medical device position notification system of the present invention may be better understood with reference to FIGS. 1-9.

Referring now to FIGS. 1A-1C, a medical device position notification system contemplated by the present invention includes: a medical device 10 and a negative pressure device 12. In this embodiment, the negative pressure device is an inflatable bulb having a body 14, an insertion end 16, and an opening 18. The medical device 10 includes a connector 20 having an access port 22 thereon configured to receive the opening 18 of the negative pressure device 12, and a catheter 30, having an attachment end 32 coupled to the connector 20 and a distal end 34. The body 14 of the negative pressure device may be comprised of a flexible material, thus being malleable. Accordingly, the body 14 of the negative pressure device 12 can be compressed and deflated when external pressure is applied to the sides of the body 14, i.e. when squeezed. Similarly, the body 14 of the negative pressure device 12 can be easily re-inflated when a positive pressure force is applied. The negative pressure device 12 includes an insertion end 16 that can be attached to the access port 22 of the connector 20. The insertion end 16 may be removably secured to the access port 22 of the connector 20 via any acceptable means known in the art. In certain embodiments, the negative pressure device 12 may be permanently affixed to or permanently secured to the access port 22 of the connector 20. (Not shown in FIGS. 1A-1C). The catheter 30, includes an attachment end 32 that may be removable secured to the connector 20 via any acceptable means known in the art. In certain embodiments, the attachment end 32 of the catheter 30 may be permanently secured to the connector 20. The catheter 30 further includes a distal end 34 that may be inserted into an orifice of a patient, i.e. the patient's nose or mouth. The distal end 34 of the catheter may be designed such that it can be guided down the esophagus into the patient's stomach. In some embodiments, it is contemplated that the negative pressure device 12, connector 20, and catheter 30 may all be permanently secured, thus comprising one device without any removable parts. In some embodiments, it is contemplated that the negative pressure device 12 may be removably attached to the medical device 10 via the connector 20.

The medical device position notification system as shown in FIGS. 1A-1C, may be utilized in the following manner. The distal end 34 of the catheter 30 is inserted into the orifice of a patient and is desirably guided down the esophagus of the patient for ultimately delivering nutrition to the patient, thus placing the catheter in the gastrointestinal tract of the patient. To determine the accurate placement of the distal end 34 of the catheter 30 in the gastrointestinal tract rather than the respiratory tract, the body 14 of the negative pressure device 12 is squeezed (See FIG. 1A), thus creating a negative pressure or vacuum along the catheter 30. Thereafter, if the body 14 of the negative pressure device 12 remains depressed or collapsed after being squeezed, it can be confirmed that the distal end 34 of the catheter 30 is correctly located in the esophagus or gastrointestinal tract of the patient. (See FIG. 1B). On the other hand, if the body 14 of the negative pressure device 12 re-inflates after being squeezed, then it can be confirmed that the distal end 34 of the catheter is incorrectly located in the trachea or airway of the patient, at which time the catheter 30 should be immediately removed and repositioned. (See FIG. 1C). Accordingly, the medical device position notification system 10, including the negative pressure device 12 described herein, allows the health care professional to immediately determine the location of the distal end 34 of the catheter 30 with ease.

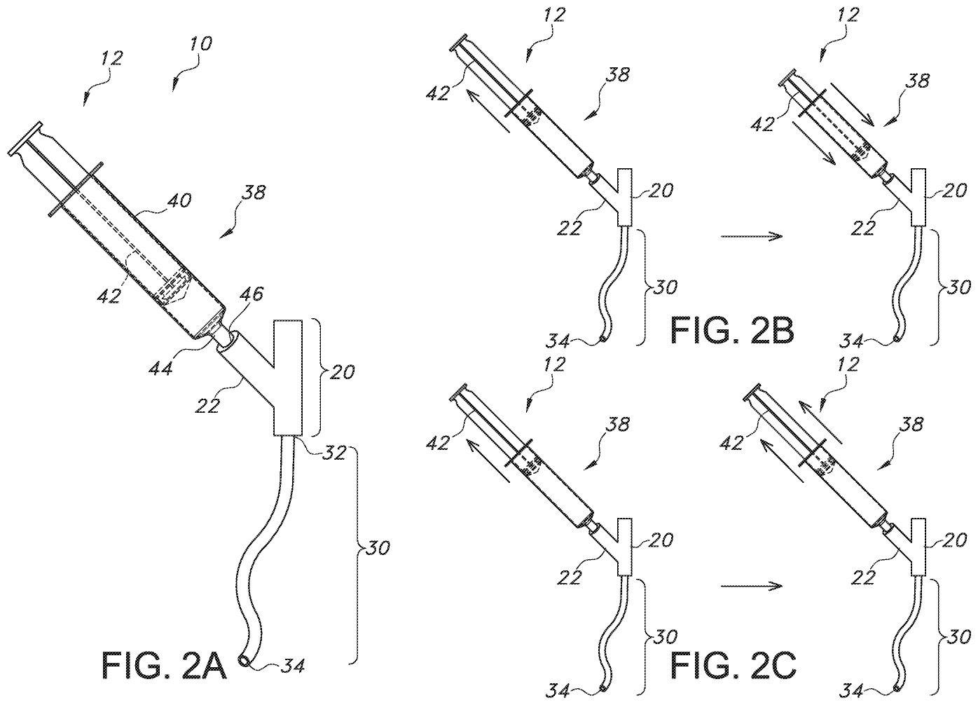

Referring now to FIGS. 2A-2C, a medical device position notification system contemplated by the present invention includes a medical device 10 and a negative pressure device 12. In this embodiment, the negative pressure device 12 is a syringe 38 having a syringe body 40, a plunger 42, a syringe insertion end 44, and a syringe opening 46. The medical device 10 includes a connector 20 having an access port 22 configured to receive the syringe opening 46 of the negative pressure device 12, and a catheter 30, having an attachment end 32 that may be attached to the connector 20 and a distal end 34. The syringe includes a syringe body 40 having a plunger 42 disposed therein. The plunger 42 is designed to be easily manipulated, i.e. retracted or pushed forward, within the syringe body 40. The syringe further includes a syringe insertion end 44 that may be attached to the access port 22 of the connector 20. The syringe insertion end 44 may be removably secured to the access port 22 of the connector 20 via any acceptable means known in the art. In certain embodiments, the negative pressure device 12 (i.e. the syringe) may be permanently secured to the access port 22 of the connector 20. (Not shown in FIGS. 2A-2C). The catheter 30, includes an attachment end 32 that may be removable secured to the connector 20 via any acceptable means known in the art. In certain embodiments, the attachment end 32 of the catheter 30 may be permanently secured to the connector 20. The catheter 30 further includes a distal end 34 that may be inserted into an orifice of a patient, i.e. the patient's nose or mouth. The distal end 34 of the catheter 30 may be designed such that it can be guided down the esophagus into the patient's stomach. In some embodiments, it is contemplated that the negative pressure device 12, connector 20, and catheter 30 may all be permanently secured, thus comprising one device without any removable parts. In some embodiments, it is contemplated that the negative pressure device 12 is removably attached to the medical device 10 via the connector 20. The medical device position notification system, including the negative pressure device 12 as shown in FIGS. 2a-2c, may be utilized in the following manner. The distal end 34 of the catheter 30 is inserted into the orifice, i.e. opening of the nose or mouth, of a patient and is desirably guided down the esophagus of the patient for ultimately delivering nutrition to the patient, thus placing the catheter in the gastrointestinal tract of the patient. To determine the accurate placement of the distal end 34 of the catheter 30 in the gastrointestinal tract rather than the respiratory tract, the plunger 42 may be retracted within the syringe body 40 creating a vacuum or negative pressure or vacuum when drawn back. (See FIG. 2A). Thereafter, if the plunger 42 returns back to its original position within the syringe body 40, then it can be confirmed that the distal end 34 of the catheter 30 is correctly located in the esophagus or gastrointestinal tract of the patient. (See FIG. 2B). On the other hand, if the plunger 42 does not return back to its original position within the syringe body 40, then it can be confirmed that the distal end 34 of the catheter is incorrectly located in the trachea or airway of the patient at which time the catheter 30 should be immediately removed and repositioned. (See FIG. 2C). Accordingly, the medical device position notification system, including the negative pressure device 12 described in this embodiment herein, allows the health care professional to immediately determine the location of the distal end 34 of the catheter 30 with ease.

In some embodiments, the negative pressure device includes any device suitable in the art that is capable of creating a vacuum or negative pressure. While an inflatable bulb and syringe are shown in the embodiments herein, the negative pressure device is not limited to only these embodiments and may include any device capable of creating a vacuum or suction.

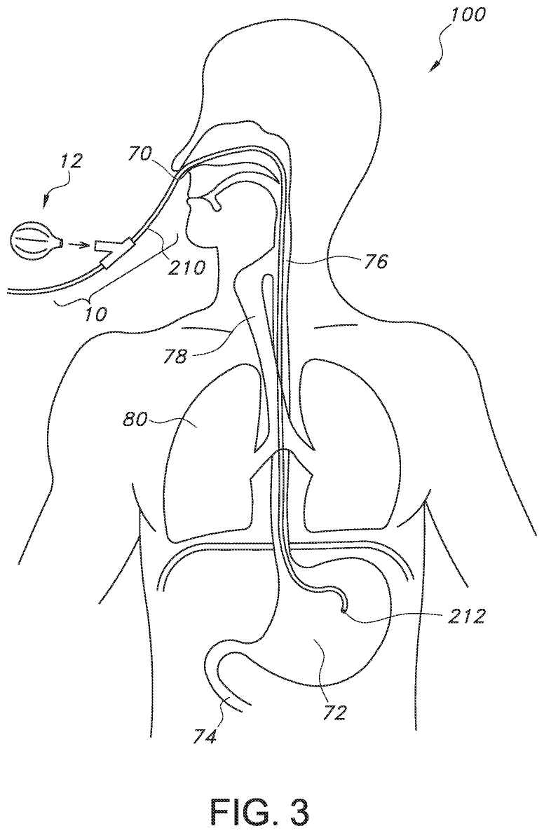

In certain embodiments, the negative pressure device 12 may be used in conjunction with a variety of implantable medical device, e.g., catheter, applications. In one application illustrated in FIG. 3, the negative pressure device 12 is used in an enteral application. Here, a portion of the medical device 10, in this case an enteral catheter, is placed through an orifice 70 of the patient 100, such as the patient's nose or mouth. The enteral catheter may include a tube 210 that is inserted into the orifice 70 of the patient. The tube 210 includes a distal end 212 in order to deliver nutrition to the patient that may be positioned in the stomach 72 or small intestine 74 of the patient 100. The negative pressure device may be connected to an access port 22 of the tube 210. In other embodiments, the negative pressure device 12 may can be connected directly to the catheter tube 210 (not shown). The distal end or tip 212 of the medical device 10 can ultimately be positioned in the stomach 72 or the small intestine 74. However, misplacement of the distal end 212 in the patient's respiratory tract, e.g., the trachea, bronchi, or lungs, rather than in the patient's gastrointestinal tract is a complication of insertion of enteral catheters due to the bifurcation of the esophagus 76 and the trachea 78. It is known that the bifurcation of the esophagus 76 and the trachea 78, as illustrated in FIG. 3, occurs at a certain distance from the entrance to the nostril in a patient 100, with the certain distance varying between pediatric and adult patients. Knowing this distance for a given patient, as well as the length of the enteral catheter tube 210, the user can determine how much (or what length) of the tube 210 has been inserted into the patient and, thus, know whether the distal end 212 of the tube 210 is at or near the point where the trachea branches off from the digestive tract, from which the tube 210 could be misplaced into the patient's airway. As an example, bifurcation typically occurs around 18-20 cm from the entrance to the nostril in adults; the area where bifurcation occurs may be referred to as a bifurcation zone.

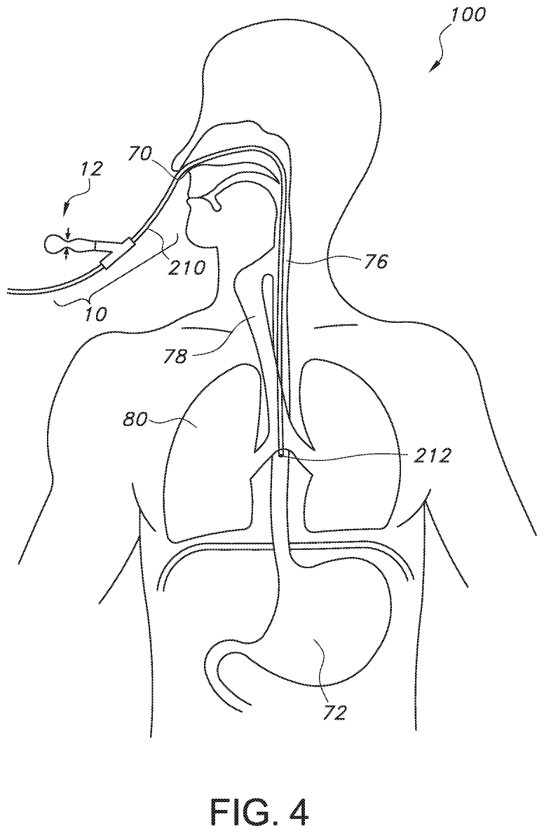

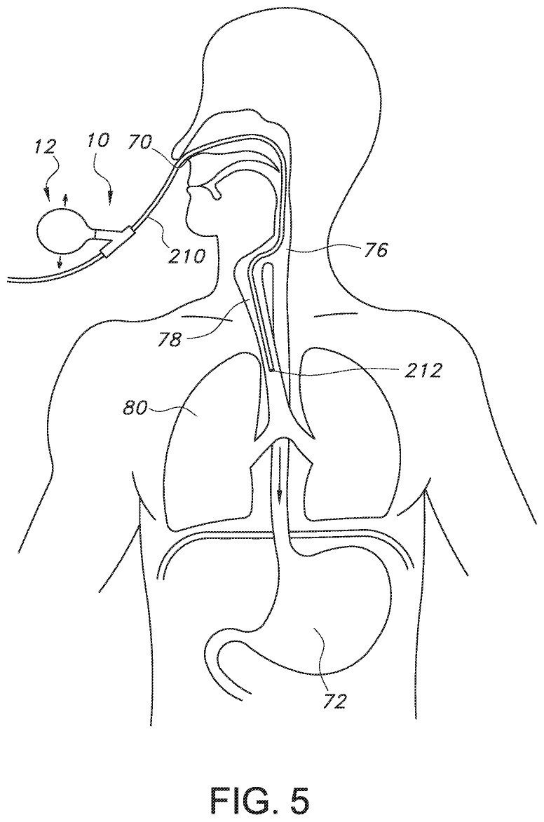

Accordingly, as the health care provider advances the medical device 10 towards the patient's stomach 72 or when the health care provider believes they may be close to the bifurcation zone, they can compress and then release the negative pressure device 12, e.g. a bulb as show in FIG. 3, either manually or mechanically, to create negative pressure within the catheter tube 210. The negative pressure device 12 can be manually compressed and observed by a healthcare provider to determine the vacuum decay, and thus the position, of the medical device 10. The location confirmation of the distal end 212 of the tube 210 can be made as follows: (1) if the bulb does not re-inflate, the distal end 212 of the tube 210 is in the esophagus 76 and placement can continue through the digestive tract (see FIG. 4), but (2) if the bulb does re-inflate, the distal end 212 of the tube 210 is in the airway, e.g. the trachea 78 or lungs 80, and the tube 210 should be repositioned (see FIG. 5).

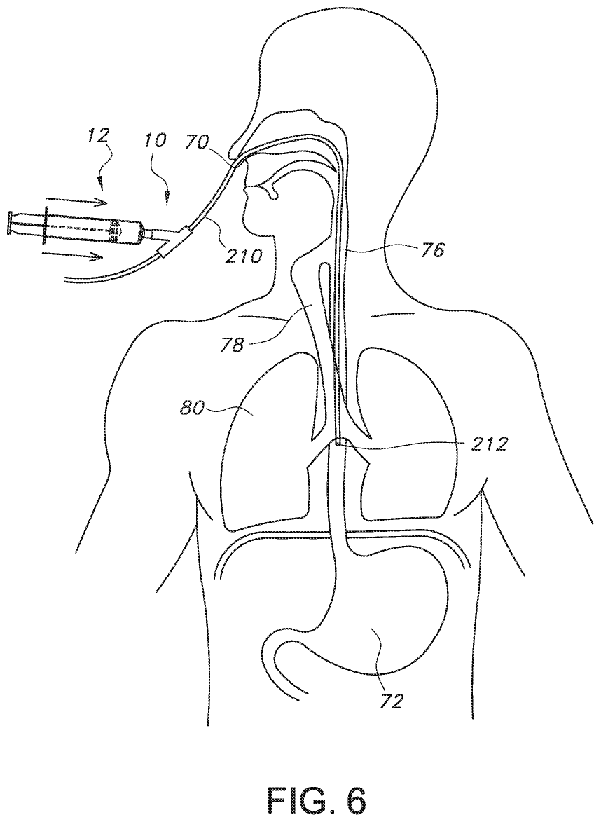

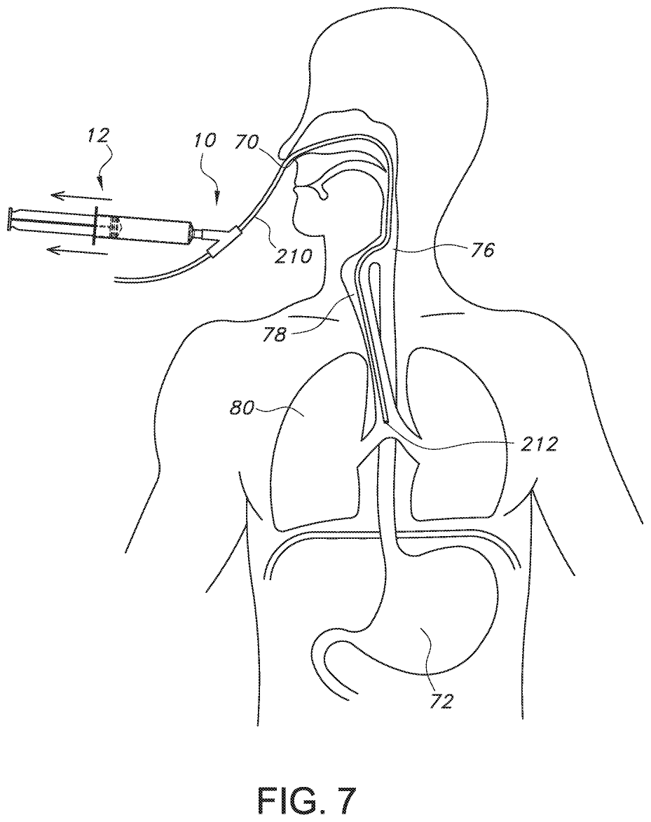

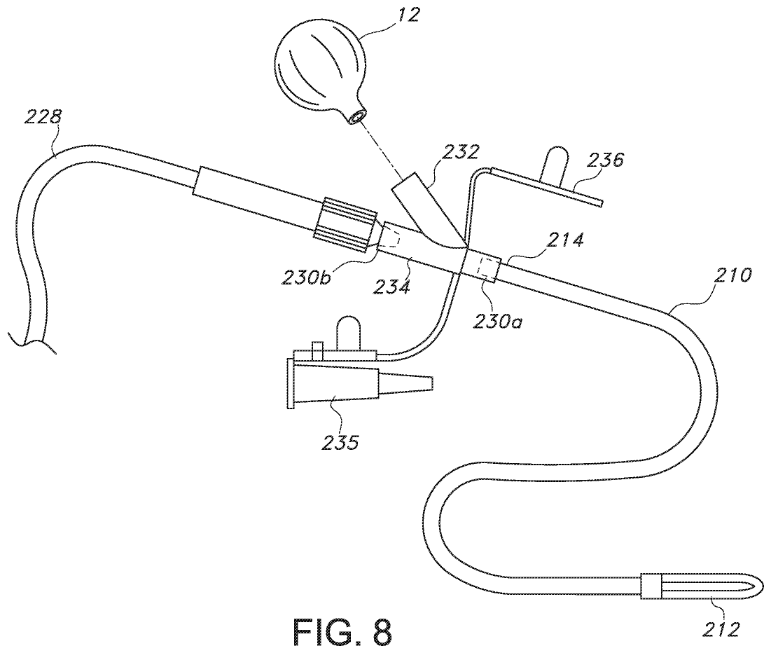

In embodiments where the negative pressure device 12 comprises a syringe, the location confirmation of the distal end 212 of the tube 210 can be made as follows: upon retraction of the plunger of the syringe (1) if the plunger returns back to its original position, i.e. the location or position of the plunger inside the syringe body 40 before it is retracted by the user (indicated by the downward arrows), the distal end 212 is in the esophagus 76 and placement can continue through the digestive tract (see FIG. 6), but (2) if the plunger does not return back to its original position and remains retracted (indicated by the upward arrows), the distal end 212 is in the trachea 78 or lungs 80, and the tube 210 should be repositioned (see FIG. 7). In some embodiments, following placement confirmation, the negative pressure device 12 may be removed or disconnected from the tube 210 of the medical device 10. Turning now to FIG. 8, in certain embodiments the medical device 10, may include a catheter, such as an enteral feeding tube 210. The enteral feeding tube 210 extends from a distal end 212 to a proximal end 214 and can be connected to a distal end 230a of a connector 230 at the proximal end 214 of the feeding tube 210. The connector 230 may also include a proximal end 230b. The connector 230 can extend along a longitudinal axis with a lumen 234 extending therebetween. Both the distal end 230a and proximal end 230b of the connector 230 can contain openings in communication with the lumen 234 and configured to receive the feeding tube 210. Optionally, the connector 230 can also include a cap or cover 235 configured to close the opening at the proximal end 230b of the connector 230. Optionally, the connector 230 can also include a cap or cover 235 configured to close the opening at the proximal end 230b of the connector 230. In addition, the connector 230 can include a Y-port 232 in communication with the lumen 234 and the opening at the distal end 230a. The Y-port 232 can additionally have a cap or cover 236 configured to close the opening at the proximal end 232a of the Y-port. The Y-port 232 can be configured to receive tubing or other suitable means for delivering enteral feeding fluid, medicine, or other fluids through the feeding tube 210. The medical device 200 may optionally include a tubing assembly 228 configured to connected to the connector 230 at the proximal end 230b of the connector. The tubing assembly 228 may be connected to a nutrition or medication source (not shown), and thus provide nutrition or medication through the connector 230 into the feeding tube 210, which ultimately provides nutrition and/or medication to the patient. The negative pressure device 12 can be configured to be coupled to the Y-port 232 in order to create a vacuum within the enteral feeding tube 210. In this manner, a healthcare provider can utilize the negative pressure device 12 in order to confirm the placement of the distal end 212 of the feeding tube 210. In some embodiments, the negative pressure device 12 may be coupled to or attached to the connector 230 and left in place during delivery of nutrition or medication to the patient.

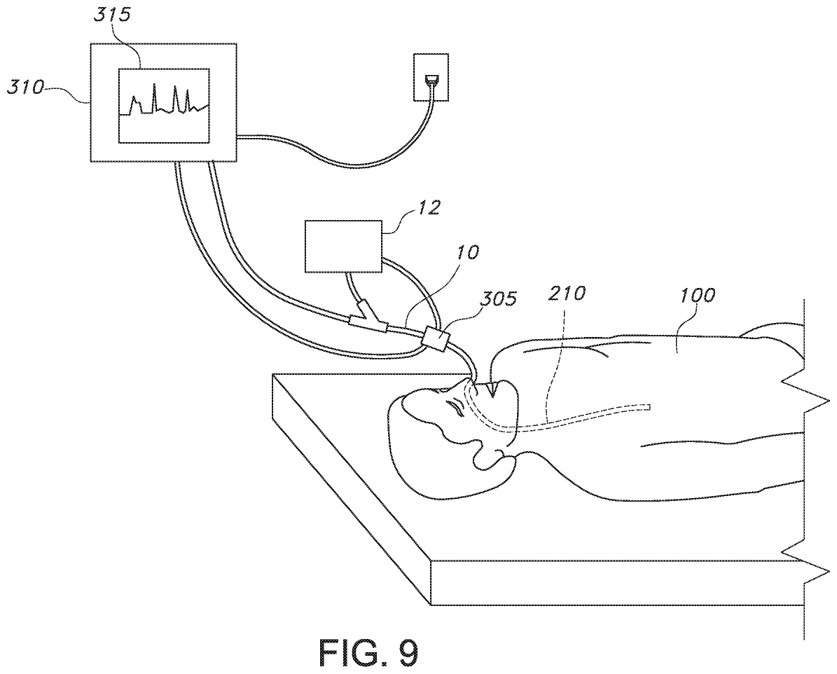

In other aspects, shown in FIG. 9, the medical device positioning system may include a medical device 10 and a negative pressure device 12 that is electrically connecting to at least one sensor 305, via a wired or wireless connection. The negative pressure device 12 is configured to be coupled with the medical device 10. The negative pressure device 12 may be manually controlled or mechanically controlled in order to generate a negative pressure within the tube 210 of the medical device 10. The negative pressure device 300 is electrically connected via a wired or wireless connection to a sensor 305. The sensor 305 measures information about the vacuum decay in the tube 210, which relates to the position of the medical device 10 within the patient's body. The sensor 305 may be located externally to the tube 210 (as shown in FIG. 9), inside the tube 210 of the medical device 10 (not shown), within the negative pressure device 12 itself (not shown), or within the processor 310 (not shown). The sensor 305 may include a plurality of external detector devices designed to electrically receive signal information regarding the vacuum decay in the tube 210. The sensor 305 may be coupled to a processor 310, either via a wired or wireless connection, to send signals or communicate information about the vacuum decay in the tube 210 to the processor 310. The processor 310 is configured to interpret the signals or information sent from the sensor 305. The processor 310 may be coupled to a display device 315, which displays the information relating to the position of the medical device 10 within the patient's body 100. The display device 315 may relay real time information regarding the vacuum pressure in the tube 210 during placement of the tube 210 in the patient's body.

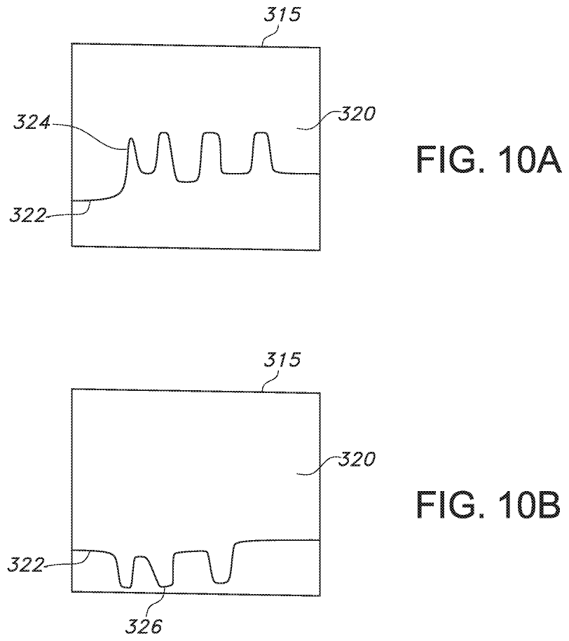

The negative pressure device 12 is configured to generate a low level of vacuum suction that is continuously pulled through the tube 210. As the tube 210 is advanced through the body, pressure readings detected by the sensor 305, change based on the vacuum resistance sensed at the distal end 212 of the tube 210. For example, when the distal end 212 of the tube 210 is in free airspace, such as the trachea, the vacuum pressure signal will be low. Whereas, if the distal end 212 of the tube 210 is in contact with tissue, e.g. in the esophagus, the vacuum pressure signal will be higher. The display device 315 may provide information regarding the location of the distal end 212 of the tube 210, such as in the form of a graph 320. (See FIGS. 10A and 10B.). The y-axis of the graph 320 corresponds to vacuum pressure signal and the x-axis of the graph corresponds to time. Although, in other embodiments, the y-axis may correspond to time and the x-axis may correspond to vacuum pressure signal. (Not shown). Accordingly, the graph 320 may illustrate the vacuum pressure at the distal end 212 of the tube 210 over time. As shown in FIG. 10A, when the distal end of the tube 212 is in the esophagus or gastrointestinal tract, the graph 320 will begin showing areas of higher vacuum pressure 324 as compared to the baseline vacuum pressure 322. As shown in FIG. 10B, however, when the distal end of the tube 212 is in the trachea or respiratory tract, the graph 320 will begin showing areas of lower vacuum pressure 326 as compared to the baseline vacuum pressure 322. Accordingly, differentiating between these two signals allows for location identification of the distal end 212 of the tube 210 to be known in real time throughout the course of placing the tube 210 in the patient's body. Thus, the location of the distal end 212 of the tube 210 can be made as follows: (1) if the sensor 305 begins to measure a higher vacuum resistance within the tube 210, then the distal end 212 of the tube 210 is in the esophagus 76 and placement can continue through the digestive tract, but (2) if the sensor 305 measures no change in the vacuum resistance of the tube 210 or a lower vacuum resistance within the tube 210, the distal end 212 of the tube 210 is in the airway, e.g. the trachea 78 or lungs 80, and the tube 210 should be repositioned. Following placement confirmation of the tube 210, the negative pressure device 12 may be removed from the tube 210.

In some embodiments, the medical device positioning system described herein may be used in conjunction with other suitable types of medical device monitoring systems, including but not limited to: carbon dioxide monitoring systems, light sensors, and sound sensors. Further, the negative pressure device 12 described herein may be used in conjunction with other types of medical device position detectors, such as position detector signal generators, e.g. electromagnetic field generator systems, in order to confirm placement of the medical device in a patients' body. In these embodiments, while a signal generator may be utilized to communicate the placement of the medical device during and after insertion into the patient's body, the healthcare provide can utilize the negative pressure device disclosed herein to confirm the placement of the medical device.

In certain aspects, provided herein are methods for medical device position guidance that include the steps of: providing a medical device; providing a negative pressure device; inserting the medical device into an orifice of the body; activating the negative pressure device to create negative pressure or a vacuum; and observing the negative pressure device or a display device configured to the negative pressure device in order to determine the position of the medical device within the patient's body. In certain embodiments, the negative pressure device is an inflatable bulb or a syringe. In some embodiments, the negative pressure device is any suitable device capable of generating a negative pressure or vacuum within the medical device.

Although the above embodiments related to positioning an end or distal tip of a catheter, it should be appreciated that the medical device position notification system is operable to assist in the placement of any medical device or insertable component into a mammal in the course of stent placement, ablation, blockage removal, heat treatment, surgical procedure, fluid delivery or any other suitable invasive procedure. It should be appreciated that any type of catheter may be used for any of the medical procedures described above. It should also be appreciated that any suitable invasive or insertable medical device can be used in place of a catheter.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they include structural elements that do not differ from the literal language of the claims or if they include equivalent structural elements with insubstantial differences from the literal language of the claims.

What is claimed is:

1. A medical device position notification system comprising:
a medical device, wherein at least a portion of the medical device is configured to be inserted into a patient's body; and
a negative pressure device, wherein the negative pressure device is configured to provide information relating to the position of the medical device in the patient's body.

2. The medical device position notification system of claim 1, wherein the negative pressure device comprises an inflatable bulb.

3. The medical device position notification system of claim 2, wherein when the bulb is deflated by an external force and re-inflates, the medical device is in the trachea or respiratory tract of the patient's body.

4. The medical device position notification system of claim 2, wherein when the bulb is deflated by an external force and does not re-inflate, the medical device is in the esophagus or gastrointestinal tract of the patient's body.

5. The medical device position notification system of claim 1, wherein the negative pressure device comprises a syringe, wherein the syringe comprises a plunger and a syringe body.

6. The medical device position notification system of claim 5, wherein the plunger comprises an original location within the syringe body, wherein the original location is the location of the plunger in the syringe body prior to retraction, wherein when the plunger is retracted within the syringe body and does not return to its original position within the syringe body, the medical device is in the trachea or the respiratory tract of the patient's body.

7. The medical device position notification system of claim 5, wherein the plunger comprises an original location within the syringe body, wherein the original location is the location of the plunger in the syringe body prior to retraction, wherein when the plunger is retracted within the syringe body and returns to its original position within the syringe body, the catheter is in the esophagus or gastrointestinal tract of the patient's body.

8. The medical device position notification system of claim 1, wherein the negative pressure device is configured to be electrically connected to at least one sensor, wherein the at least one sensor measures information relating to the position of the medical device within the patient's body and sends signals containing the information relating to the position of the medical device within the patient's body to a processor via a wired or wireless electrical connection in real-time, further wherein a display device is coupled to the processor and displays information relating to the position of the medical device within the patient's body communicated by the at least one sensor.

9. The medical device position notification system of claim 1, wherein the medical device comprises a catheter.

10. The medical device position notification system of claim 9, wherein the catheter is configured to be inserted into at least one orifice the patient's body.

11. The medical device position notification system of claim 10, wherein the at least one orifice comprises a nose or a mouth.

12. The medical device position notification system of claim 9, wherein the negative pressure device is coupled to the catheter via a connector.

13. The medical device position notification system of claim 12, wherein the connector comprises an access port or Y-port.

14. A method for medical device position guidance comprising:
providing a medical device, wherein at least a portion of the medical device is configured to be inserted into the body;
providing a negative pressure device, wherein the negative pressure device is configured to be coupled to the medical device;
inserting the medical device into an orifice of the body;
activating the negative pressure device to generate negative pressure or a vacuum; and
observing the negative pressure device or a display device configured to the negative pressure device to determine the position of the medical device within the patient's body.

15. The method of claim 14, wherein the orifice is a nose or a mouth.

16. The method of claim 14, wherein the negative pressure device comprises an inflatable bulb.

17. The method of claim 16, wherein the activation step comprises deflating the bulb by an external force, wherein if the bulb re-inflates, the medical device is in the trachea or respiratory tract of the patient's body.

18. The method of claim 16, wherein the activation step comprises deflating the bulb by an external force, wherein if the bulb does not re-inflate, the medical device is in the esophagus or gastrointestinal tract of the patient's body.

19. The method of claim 14, wherein the negative pressure device comprises a syringe, wherein the syringe comprises a plunger and a syringe body.

20. The method of claim 19, wherein the activation step comprises retracting the plunger within the syringe body, wherein the plunger has an original position within the syringe body comprising the location of the plunger within the syringe body prior to retraction, wherein if the syringe plunger does not return to its original position within the syringe body, the medical device is in the trachea or respiratory tract of the patient's body.

21. The method of claim 19, wherein the activation step comprises retracting the plunger within the syringe body, wherein the plunger has an original position within the syringe body comprising the location of the plunger within the syringe body prior to retraction, wherein if the syringe plunger returns to its original position within the syringe body, the medical device is in the esophagus or the gastrointestinal tract of the patient's body.

22. The method of claim 14, wherein the negative pressure device is configured to be electrically connected to at least one sensor, wherein the at least one sensor measures information relating to the position of the medical device within the patient's body and sends signals containing the information relating to the position of the medical device within the patient's body to a processor via a wired or wireless electrical connection in real-time, further wherein the display device is coupled to the processor and displays information relating to the position of the medical device within the patient's body communicated by the at least one sensor.

23. The method of claim 14, wherein the medical device comprises a catheter.

24. The method of claim 23, wherein the negative pressure device is coupled to the catheter via a connector.

25. The method of claim 24, wherein the connector comprises and access port or a Y-port.
